(19) United States
(12) Patent Application Publication
(10) Pub. No.: US 2008/0127771 A1
(43) Pub. Date: Jun. 5, 2008

(54) Steering wheels with integrally molded positive temperature coefficient materials

(75) Inventor: Steven Stoll, Macomb, MI (US)

Correspondence Address: JOHN S. BEULICK (19121), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/633,982

(22) Filed: Dec. 4, 2006

(51) Int. Cl. B62D 1/08; B62D 1/06; B62D 1/10; B28B 23/00

(52) U.S. Cl. 74/552; 264/254

(57) ABSTRACT

A heated steering wheel for an automotive vehicle includes, in an exemplary embodiment, a center hub, a rim, and a plurality of spokes connecting the rim to the center hub. The rim includes a center core and a polymeric PTC material over-molded around at least a portion of the center core of the rim.

### BACKGROUND OF THE INVENTION

This invention relates generally to steering wheels for automotive vehicles, and more particularly to steering wheels with integrally molded positive temperature coefficient materials for self limiting heating of the steering wheels.

Known steering wheels include a metal armature that forms the spokes, the rim, and the hub of the steering wheel. The armature is usually fabricated as a single piece or formed from separate parts that are welded or joined together with fasteners. The armature is encapsulated by an appropriate covering material such as wood, elastomeric materials, for example, polyurethane materials, or a combination of materials.

Automobile manufacturers would like to be able to sell heated steering wheels, especially for vehicles operated in cold environments. Known steering wheel heaters are limited to heat tape designs. These steering wheel heaters typically include a resistance wire, switches, a timer, and/or a temperature controller. The switches and temperature controllers are used to prevent the steering wheel from becoming too hot. These types of steering wheel heaters include multiple components that increase manufacturing costs and labor costs.

### BRIEF DESCRIPTION OF THE INVENTION

A heated steering wheel for an automotive vehicle is provided. The heated steering wheel includes a center hub, a rim, and a plurality of spokes connecting the rim to the center hub. The rim includes a center core and a polymeric PTC material over-molded around at least a portion of the center core of the rim.

A method of forming a heated steering wheel for an automotive vehicle is provided. The steering wheel includes a center hub, a rim, and a plurality of spokes connecting the rim to the center hub. The method includes the steps of providing a rim core member, positioning the rim core member in a mold, and introducing a polymeric PTC material into the mold to over-mold at least a portion of the rim core member. The polymeric PTC material include a crystalline polymer and a plurality conductive particles.

### BRIEF DESCRIPTION OF THE DRAWINGS

FIG. 1 is a perspective schematic illustration of a heated steering wheel in accordance with an exemplary embodiment of the present invention.

FIG. 2 is a sectional schematic illustration of the rim of the heated steering wheel shown in FIG. 1.

FIG. 3 is a graph of resistance versus temperature of a PTC material.

### DETAILED DESCRIPTION OF THE INVENTION

A heated steering wheel that includes a rim that is formed from a polymeric positive temperature coefficient (PTC) material which in one exemplary embodiment is over-molded around a metal or plastic rim core is described in detail below. The PTC material in one embodiment is over-molded around substantially the entire rim core. In another embodiment, the PTC material is over-molded around specific predetermined areas of the rim core and a thermoplastic material is over-molded around the remainder of the rim core. The PTC material provides for customer selectable heating of the wheel rim in cold environments. The PTC material also provides for self regulating temperature control of the steering wheel without overheating. Because of the temperature control properties of the PTC material, resistance wires, switches, and timers and/or temperature controllers are not needed for temperature control and overheat protection.

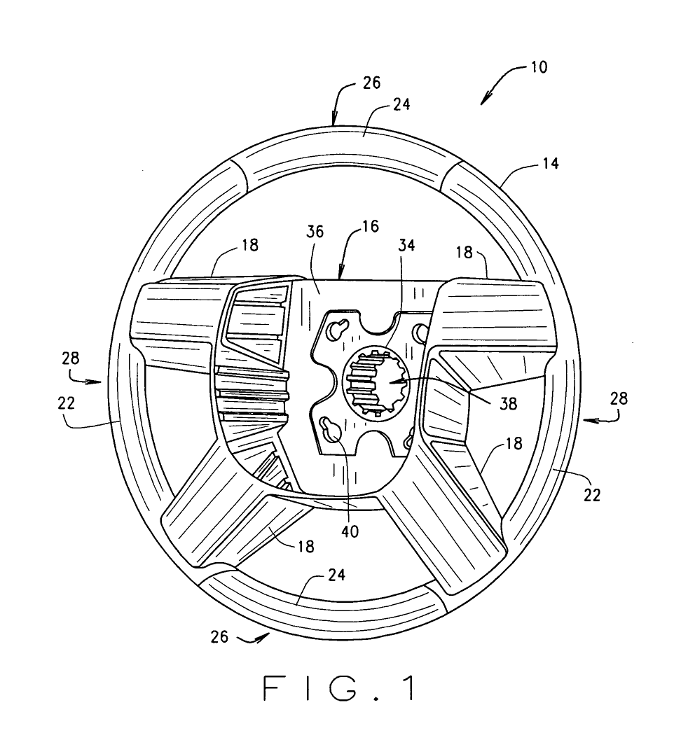

Referring to the drawings, FIG. 1 is a perspective schematic illustration of an exemplary embodiment of a heated steering wheel 10, and FIG. 2 is a sectional schematic illustration of a portion of heated steering wheel 10. Referring to FIGS. 1 and 2, heated steering wheel 10 includes a rim 14, a center hub 16, and a plurality of spokes 18 (4 shown) connecting rim 14 to center hub 16. Rim 14 is formed from a metal or plastic rim core 20 over-molded with a polymeric PTC material 22. Particularly, in the exemplary embodiment, a thermoplastic material 24 is over-molded around at least one first portion 26 of rim core 20 and polymeric PTC material 22 is over-molded over at least one second portion 28 of rim core 20. In an alternate embodiment, polymeric PTC material is over-molded around substantially the entire area of rim core 20. In another exemplary embodiment, thermoplastic material 24 is over-molded around substantially the entire area of rim core 20 and polymeric PTC material 22 is over-molded over at least a portion of thermoplastic material 24. The molded PTC material 22 is electrically coupled to a powe source, for example, the automobile battery (not shown) through electrical contacts 30 and 32.

In the exemplary embodiment, rim core 20 is a metal or plastic rod that has a circular cross section. In another embodiment, rim core 20 is a hollow tubular element. Also, in alternate embodiments, rim core 20 has a rectangular or a polygonal cross sectional shape. Any suitable metal can be used to form rim core 20, including, but not limited to, steel, aluminum, and magnesium. Also, any suitable plastic material can be used to form rim core 20, for example, silicone modified polycarbonates, nylon, polyesters, polyphenylene oxide, polypropylene, and polyurethane. Particularly, rim core 20 can be solid or hollow polymeric material. A hollow core can be achieved by water assist, gas assist, rotational molding, or other methodologies employed to achieve hollow sections in polymeric materials. Also, the material can be foamed to introduce minute gas pockets dispersed throughout the core of the material of rim core 20. The foaming can be accomplished by various methods, including but not limited to, exothermic blowing agents, introduction of liquid nitrogen or nitrogen gas during the melt phase of processing, or other such methods. In an alternate embodiment, rim 14 is formed from thermoplastic 24 without the presence of rim core 20 with at least a portion of thermoplastic material over-molded by polymeric PTC material 22.

Center hub 16 includes a center attachment portion 34 extending through a flat portion 36 of center hub 16. Attachment portion 34 includes an attachment bore 38 extending therethrough that is sized and shaped to receive the steering column (not shown) of an automobile vehicle to attach heated steering wheel 10 to the steering column. Flat portion 36 of center hub 16 also includes a plurality of airbag attachment openings 40 that are sized for attachment of an airbag unit to center hub 16 between spokes 18.

Spokes 18 and center hub 16 are formed from a metal material or thermoplastic material 24. In one embodiment, spokes 18, center hub 16 and rim core 20 are formed as a single piece metal armature which is then over-molded by thermoplastic material 24 and/or polymeric PTC material 22. In another embodiment, spokes and center hub 16 are formed from thermoplastic material 24 and are molded as one piece along with rim 14. Particularly, rim core 20 is positioned in a mold and thermoplastic material 24 is introduced into the mold so that thermoplastic material 24 forms spokes 18, center hub 16 and over-molds rim core 20 to form rim 14 with rim core 20 embedded in thermoplastic material 24. Predetermined areas of rim 14 are also over-molded with PTC material 22. Any suitable molding technique can be used, for example injection molding. A suitable thermoplastic material 24 is deformable and absorbs energy during an impact event. Examples of suitable thermoplastic materials 24 include, but are not limited to, silicone modified polycarbonate, nylon, polyesters, polyphenylene oxide, polypropylene, mixtures thereof, and foamed materials thereof. In one exemplary embodiment, silicone modified polycarbonate, commercially available from the General Electric Company under the trademark Lexan® EXL, is used.

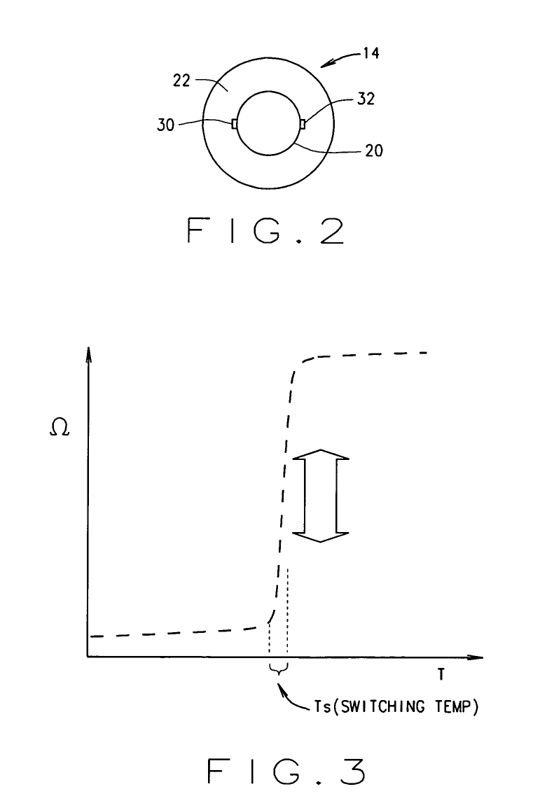

When electricity is passed through PTC material 22 it causes PTC material 22 to heat up and act as a heater thereby heating steering wheel 10. Polymeric PTC material 22 is a conductive material characterized by a sharp increase in resistivity upon reaching what is referred to as the switching temperature, Ts, shown in FIG. 3. If the jump in resistivity is sufficiently high, the resistivity effectively blocks the current and further heating of steering wheel 10. As a result, overheating of the steering wheel 10 is prevented. One benefit provided by PTC material 22 is that no additional electronic circuits are necessary to control the temperature. Moreover, upon cooling below the switching temperature, Ts, PTC material 22 resets itself. This jump in resistivity is generally referred to as the PTC amplitude and is defined as the ratio of the maximum volume resistivity to the volume resistivity at room temperature (about 23° C.).

Polymeric PTC material 22 includes a crystalline polymer that carries a dispersed filler of conductive particles, for example, conductive carbon particles, graphite particles, or metal particles. Suitable metal particles include, but are not limited to, silver, gold, nickel, and the like. In use, polymeric PTC material 22 exhibits temperature-induced changes in the base polymer to alter electrical resistance of the polymer-particle composite. In a low temperature state, the crystalline structure of the base polymer causes dense packing of the conductive particles (i.e., carbon) into its crystalline boundaries so that the conductive particles are in close proximity and allow current to flow through PTC material 22 via these conductive particle “chains”. When PTC material 22 is at a low temperature, numerous conductive particle chains form the conductive paths through the material. When PTC material 22 is heated to a selected level, the polymer base material thus will be elevated in temperature until it exceeds a phase transformation temperature. As the polymer passes through this phase transformation temperature, the crystalline structure changes to an amorphous state. The amorphous state causes the conductive particles to move apart from each other until the conductive particle chains are disrupted and no longer conduct current. Thus, the resistance of PTC material 22 increases sharply. In general, the temperature at which the base polymer transitions to its amorphous state and affects conductivity is called its switching temperature T_{S}.

In various embodiments, the crystalline polymer component of PTC material 22 can be a crystalline or semi-crystalline polymer such as a polyolefin, for example, a polyethylene or a polypropylene. The polymer also can be a copolymer of at least one olefin and one or more other monomers that can be co-polymerized with the olefin. The base polymer component also can be a polyamide, polystyrene, polyacrylonitrile, polyethylene oxide, polyacetal, polysulfones, thermoplastic polyesters, polyethyl acrylate, or polymethyl methacrylate. The co-polymers also can be a nylon, a fluoropolymer such as polyvinylidene fluoride, an ethylene tetrafluoroethylene, or blends of two or more such polymers.

While the invention has been described in terms of various specific embodiments, those skilled in the art will recognize that the invention can be practiced with modification within the spirit and scope of the claims.

What is claimed is:

1. A heated steering wheel for an automotive vehicle comprising:
a center hub;
a rim; and
a plurality of spokes connecting said rim to said center hub, said rim comprising:
a center core; and
a polymeric PTC material over-molded around at least a portion of said center core.

2. A heated steering wheel in accordance with claim 1 further comprising a thermoplastic material over-molded around at least a portion of said center core of said rim.

3. A heated steering wheel in accordance with claim 1 wherein said polymeric PTC material is electrically coupled to a source of electricity.

4. A heated steering wheel in accordance with claim 1 wherein said polymeric PTC material comprises a crystalline polymer and a plurality conductive particles.

5. A heated steering wheel in accordance with claim 4 wherein said crystalline polymer comprises at least one of polyolefin, polyamides, polystyrene, polyacrylonitrile, polyethylene oxide, polyacetal, polysulfones, thermoplastic polyesters, polyethyl acrylate, polymethyl methacrylate, nylon, and a fluoropolymer.

6. A heated steering wheel in accordance with claim 4 wherein said conductive particles comprise at least one of conductive carbon particles, graphite particles, and metal particles.

7. A heated steering wheel in accordance with claim 1 wherein a resistivity of said polymeric PTC material increases as a temperature of said polymeric PTC material increases, at a predetermined temperature, said increased resistivity sufficiently high enough to block a current through said polymeric PTC material to prevent overheating of said steering wheel.

8. A heated steering wheel in accordance with claim 1 wherein said rim core is substantially completely over-molded with said polymeric PTC material.

9. A heated steering wheel in accordance with claim 1 wherein only predetermined portions of said rim core are over-molded with said polymeric PTC material.

10. A heated steering wheel in accordance with claim 1 wherein said rim core comprises a metal material or a plastic material, said metal material comprising at least one of steel, aluminum, and magnesium, said plastic material comprising at least one of silicone modified polycarbonates, nylon, polyesters, polyphenylene oxide, polypropylene, and polyurethane.

11. A heated steering wheel in accordance with claim 1 wherein said thermoplastic material comprises at least one of silicone modified polycarbonates, nylon, polyesters, polyphenylene oxide, polypropylene, and foamed thermoplastic materials thereof.

12. A method of forming a heated steering wheel for an automotive vehicle, the steering wheel comprising a center hub, a rim, and a plurality of spokes connecting the rim to the center hub, said method comprising:
providing a rim core member;
positioning the rim core member in a mold;
introducing a polymeric PTC material into the mold to over-mold at least a portion of the rim core member, the polymeric PTC material comprising a crystalline polymer and a plurality conductive particles.

13. A method in accordance with claim 12 further comprising introducing a thermoplastic material into the mold to over-mold at least a portion of the rim core member.

14. A method in accordance with claim 12 further comprising over-molding substantially all of the rim core member with the polymeric PTC material.

15. A method in accordance with claim 12 further comprising over-molding only predetermined portions of the rim core member with the polymeric PTC material.

16. A method in accordance with claim 13 further comprising over-molding substantially all of the rim core member with the thermoplastic material and over-molding only predetermined areas of the rim core member that has been over-molded with the thermoplastic material.

17. A method in accordance with claim 12 wherein the rim core member comprises a metal material or a plastic material, the metal material comprising at least one of steel, aluminum, and magnesium, the plastic material comprising at least one of silicone modified polycarbonates, nylon, polyesters, polyphenylene oxide, polypropylene, and polyurethane.

18. A method in accordance with claim 13 wherein the thermoplastic material comprises at least one of silicone modified polycarbonates, nylon, polyesters, polyphenylene oxide, polypropylene, and foamed thermoplastic materials thereof.

19. A method in accordance with claim 12 wherein the crystalline polymer comprises at least one of polyolefin, polyamides, polystyrene, polyacrylonitrile, polyethylene oxide, polyacetal, polysulfones, thermoplastic polyesters, polyethyl acrylate, polymethyl methacrylate, nylon, and a fluoropolymer.

20. A method in accordance with claim 12 wherein the conductive particles comprise at least one of conductive carbon particles, graphite particles, and metal particles.
